(19) United States
(12) Patent Application Publication
(10) Pub. No.: US 2021/0102816 A1
(43) Pub. Date: Apr. 8, 2021

(54) DESTINATION MANAGEMENT INTERFACE FOR RIDESHARE SERVICE

(71) Applicant: William J Neylan, III, Tampa, FL (US)

(72) Inventor: William J Neylan, III, Tampa, FL (US)

(21) Appl. No.: 17/062,204

(22) Filed: Oct. 2, 2020

Related U.S. Application Data
(60) Provisional application No. 62/909,490, filed on Oct. 2, 2019.

(51) Int. Cl. G01C 21/34; G01C 21/36; G06Q 10/02

(52) U.S. Cl. CPC G01C 21/3438; G06Q 10/02; G01C 21/3605

(57) ABSTRACT

A system for management of destinations presented to a user via a ride sharing service application. The system comprises a search module for matching information in a destination database with user-selected criteria. The system displays a set of destination listings in an listing interface as part of a destination management interface deployed on a user device. Upon user selection of electronic functionality for securing a reservation at a user-selected destination identified in the set of destination listings, the system deploys a reservation interface in the destination management interface for securing a reservation for an event at a user-selected destination. Upon user selection of electronic functionality for reserving a ride deployed in a ride scheduling interface on the user device, the system deploys electronic functionality through which the user engages the ride sharing interface to schedule a ride to the user-selected destination.

### CROSS-REFERENCE TO RELATED APPLICATION

Pursuant to 35 U.S.C. § 119(e), this application claims the benefit of U.S. Provisional Patent Application Ser. No. 62/909,490, filed on Oct. 2, 2019, the entire contents of which are incorporated herein by this reference.

### BACKGROUND

### (1) Field of Endeavor

The present invention relates generally to the field of ride sharing management, and more particularly, to user management of ride sharing destinations.

### (2) Description of Related Art

Existing ride sharing interfaces on mobile devices are generally limited to ordering a ride share and the subsequent billing and payment by the user. These interfaces lack functionality that enables user engagement with certain desirable destinations, such as restaurants, bars, entertainment venues, sports arenas, and the like. For a user in an unfamiliar location or city, the user may not be able to use a ride sharing interface to locate destinations of interest. The present destination management interface seeks to overcome these problems by providing an interface through which users can search and identify desirable destinations, interface with a ride sharing service to secure a ride share to the destination, and then rate the destination for the benefit of the user community.

The present system provides a technical solution to the technical problem of integrating electronic ride sharing services with electronic destination searches. Prior systems for ride sharing services offer electronic functionality limited to reserving a ride and corresponding electronic processing of payments. By contrast, prior mobile applications and other technology for destination searching is limited to electronic searches of the destination listings or databases without offering any electronic functionality for securing or reserving a ride to the destination. Consequently, users of prior systems must juggle multiple applications, interfaces, or solutions to find and arrive at a desired destination. These prior systems lack compatibility and interoperability needed for a seamless user experience. The present system solves this technical problem by providing an system having an interface for searching destinations based on user selected criteria, securing a reservation for an event at a user selected destination, and reserving a ride to the destination at the time of the event.

### SUMMARY OF THE PREFERRED EMBODIMENTS

The system described herein is deployed via a destination management interface (“DMI”) on a user's computing device. The system generally comprises a search module, a reservation interface, and an optional destination operator interface. The DMI enables user interaction with the search module by providing electronic connectivity with an electronically deployed ride sharing system that is provided by a ride sharing service. The system provides users added electronic functionality for the identification, selection, user rating, billing, and payment related to ride sharing destinations.

In one embodiment, the has a main DMI interface, such as a graphical user interface, which provides an electronic communication link to electronic functionality incorporated into the ride sharing system. When launched, the search module provides a distance selection prompt that enables the user to select the maximum distance for possible destinations of interest. Exemplary category options of destinations of interest include restaurants, bars, entertainment, and retail. After receiving user selected criteria comprising the user's selection of the distance and destination category, a search module in the system searches a destination database or other data store for destinations that match this criteria and returns a results list to the user.

The search module further provides a listing interface via the DMI, the listing interface being an interface in the DMI through which a list of destinations is presented, where the listed destinations are derived from the DMI's database search based on the user selected criteria. These criteria include information, categories, and subcategories of destinations.

The reservation interface comprises a reservation interface deployed via the DMI. The reservation interface provides electronic functionality that enables the user to electronically submit and secure a reservation for an event at the selected destination. For example, the user could engage the reservation interface electronic functionality to secure a reservation at a restaurant, reserve space on a tour, reserve a private viewing at a museum, or reserve space at similar events. The reservation interface presents the user with a reservation system that queries whether the user would like to make such a reservation. If the user selects a positive answer to the reservation query, the DMI submits the user's reservation request either directly to the destination operator, or through a third party electronic platform.

Once a reservation is completed by the user, the DMI presents the user with a ride scheduling interface, which comprises electronic functionality through which the user engages the ride sharing service to schedule a ride.

While the user is waiting for the ride to arrive for pickup, the system presents the user with an audiovisual display via the DMI, which displays multimedia advertisements and promotions in connection with the ride sharing service, the destination operator, or another advertiser. After the ride is completed and the user is dropped off at the destination, the DMI presents the user with a rating interface, which comprises electronic functionality that enables a user to enter a rating of the destination and to write a review of the destination.

One embodiment of the system further comprises a destination operator interface accessible via a destination operator interface (“DOI”), the destination operator interface providing electronic functionality through which a destination operator engages the DMI. After the destination operator accesses the destination operator interface via the DOI, the DOI presents the destination operator with a destination category prompt, which provides or engages electronic functionality through which the DMI receives destination category information entered by the destination operator about the destination. The destination category prompt cues the destination operator to enter or select the type of destination, whether a restaurant, sports venue, bar, or some other destination.

The DOI may also present the destination operator with a destination subcategory prompt, which provides or engages electronic functionality through which the DMI receives information entered by the destination operator about the destination subcategory. The destination subcategory prompt presents a cue to the destination operator to enter or select information responsive to the subcategory options of the destination.

### BRIEF DESCRIPTION OF THE DRAWINGS

FIG. 1 is a diagram showing the electronic communication connectivity of the parties using the present destination management interface through their respective devices.

FIG. 2 is a diagram showing the flow of one embodiment of the destination management interface of the preset system.

FIG. 3 is a diagram showing one embodiment of selected features of the destination management interface.

FIG. 4 is diagram showing the flow of the destination operator interface portion of the destination management interface.

FIG. 5 is diagram of one embodiment of a system for deploying a destination management interface.

### DESCRIPTION OF THE PREFERRED EMBODIMENT

With reference to the drawings, the destination management system will now be described with regard for the best mode and the preferred embodiment. In general, the destination management system is an electronically deployed system through which the user of a ride sharing service enables management of ride sharing destinations. The embodiments disclosed herein are meant for illustration and not limitation of the invention. An ordinary practitioner will appreciate that it is possible to create many variations of the following embodiments without undue experimentation.

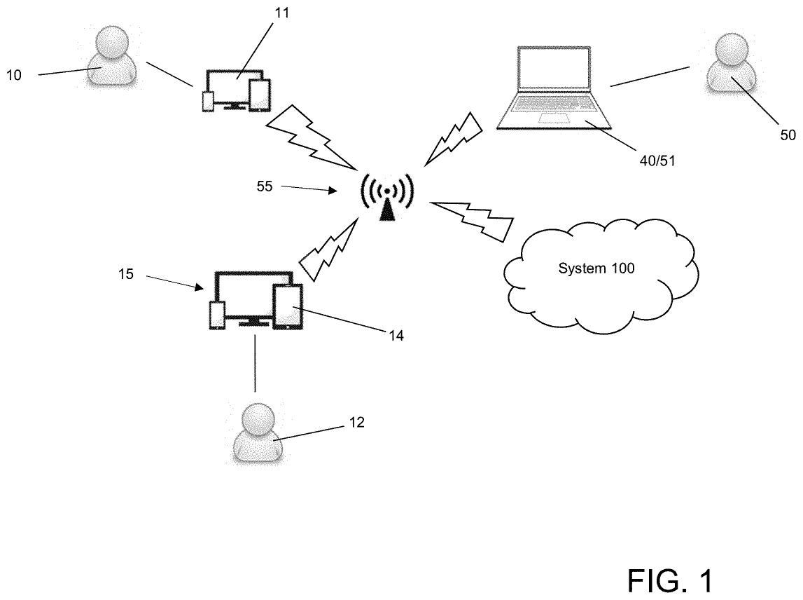

Referring to FIG. 1, the destination management system 100 is deployed on a mobile device 14 of a user 12 via a destination management interface 15 (“DMI”). The DMI 15 enables electronic connectivity with an electronically deployed ride sharing system 11 that is provided by a ride sharing service 10. The ride sharing system 11 is typically accessible via a mobile application, a mobile web page, or similar electronically deployed interface that enables users 12 to interact with the ride sharing service 10, such as by calling for a ride, paying for a ride, selecting one or more destinations, modifying the user's 12 account information, or monitoring the location or status of a called, reserved, or in progress ride. The DMI 15 further provides users 12 added electronic functionality for the identification, selection, user rating, and billing and payment related to ride sharing destinations. For example, in one embodiment, the DMI 15 is an add-in or plug-in to the ride sharing system 11. In another embodiment, the DMI 15 is a stand-alone mobile or web application, and the ride sharing system 11 redirects the user 12 to the stand-alone DMI 15. Generally, the system 100 described herein is accessible by a user 12 via the DMI 15.

In one embodiment, the DMI 15 communicates with the ride sharing system 11 via a wireless network 55, which comprises communication via one or more wireless protocols, such as cellular, Wi-Fi, Bluetooth, 802.11, and other protocols. Networking protocols for communication over the wireless network 55 comprise transmission control protocol/Internet protocol (TCP/IP), simple mail transfer protocol (SMTP), hypertext transport protocol (HTTP), or other protocols capable of exchanging data in extensible markup language (XML), hypertext markup language (HTML), or other suitable markup languages.

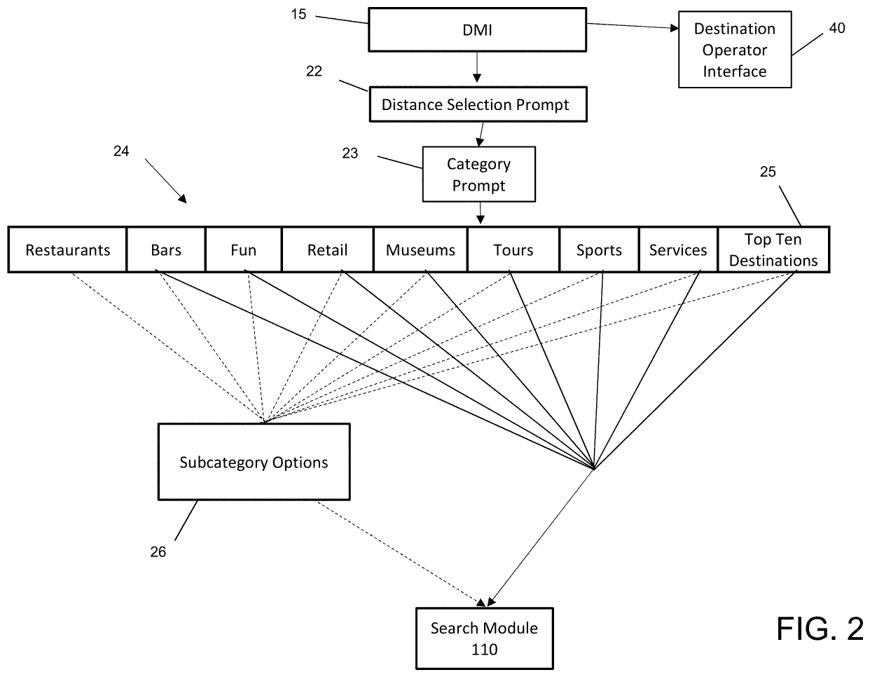

In one embodiment, referring to FIG. 2, the DMI 15 has a graphical user interface, or some other interface, which provides an electronic communication link to electronic functionality incorporated into the ride sharing system 11. When launched, the DMI 15 provides one or more prompts for a user to enter user-selected data. This could include a list of user preferences, such as a distance selection prompt 22, which prompts the user 12 to select the maximum distance (in mileage or kilometers) for possible destinations of interest to the user 12. The DMI 15 uses this information in connection with the destination electronic functionality in the ride sharing system 11 to find locations within a radius of the maximum distance selected.

The DMI 15 then provides the user 12 with a category prompt 23, which prompts the user 12 for a category of possible destinations within the distance radius chosen through the distance selection prompt 22. Exemplary category options 24 include restaurants, bars, entertainment, retail, museums, tours, sports, services, and top ten destinations. In one embodiment, the DMI 15 further includes subcategory options 26 of one or more category options 24. For example, under the restaurant category option 24, the subcategory options 26 are arranged by a feature of restaurants, such as type of cuisine, price point, ambiance (e.g., formal or casual), or other features. The user 12 accesses these subcategory options 26 by selecting the “Restaurants” category option 24 from the category prompt 23. One option under the restaurant subcategory option 26 is a listing of cuisines, such as American, breakfast, burgers, Chinese, coffee, deserts, Italian, Mexican, pizza, sandwiches, sushi, steak, seafood, and the like. When the user 12 selects one or more of these subcategory options 26, the DMI 15 refines the restaurant locations and listings using this additional, user 12 defined criteria. After performing the supplemental search of a destination database, the DMI 15 presents only the restaurants that meet the additional criteria by falling into the subcategory option 26 and excluding restaurant destinations that do not offer the cuisine of the subcategory option 26 selected.

As another example, the sports category option 24 further presents subcategory options 26 based on the type of sport, the nature of competition (e.g., professional or amateur, men or women, etc.), the price point of tickets, the types of tickets available (e.g., general admission, club level, etc.), or some other feature. The DMI 15 performs a search based on user 12 defined criteria in the same manner as that described above.

The top ten destinations category option 25 is determined from information derived from prior users 12 of the ride sharing system 11. In one embodiment, the top ten destinations category option 25 is configured such that if a user 12 selects the top ten destinations category option 25, the DMI 15 returns to the user 12 the top ten most frequently visited destinations located within the user's 12 selected distance radius. In another embodiment, the top ten destinations category option 25 is configured such that if a user 12 selects the top ten destinations category option 25, the DMI 15 returns to the user 12 the top ten highest rated destinations located within the user's 12 selected distance radius. In this embodiment, the DMI 15 uses a rating system operated by the ride sharing service 10 based on self-reported data entered by prior users 12 of the ride sharing system 11.

The DMI 15 receives the user 12 selected criteria comprising the user's 12 selection of the distance and destination category, as well as other criteria entered by the user in response to the category options 24 and subcategory options 26. As part of the user 12 selected criteria, the user 12 may also provide an order of preference, or a hierarchy, for various search criteria, such as price point, type of restaurant, and distance. Based on this collective user 12 selected criteria, the DMI 15 engages the search module 110 that uses a model to generate a rule set to apply to information in a destination database based upon the user 12 selected criteria and the user 12 specified search request, the rule set adapted to generate a set of destination listings most relevant to the user-selected criteria and the user-specified search request. In generating the rule set, the model accommodates the order of preference in relation to the user 12 specified criteria. For example, the search module 110 may prioritize a listing for a relatively high priced restaurant that is a shorter distance from the user 12 over a lower priced restaurant that is a further distance from the user 12 if the user 12 identifies proximity as more important than price point.

The destination database is a database that stores data and information related to various destinations. Such information may be gathered from public listings, such as address and hours of operation, or reported by operators of the destination. The latter category of information may relate to specials, limited time offers, discounts, special events, or the like. The database may also include data and information that is reported by visitors to the destination, and such information may include visitor reviews, comments from visitors about their experience (e.g., the museum is cold, so bring a sweater), or visitor recommendations (e.g., arrive early for best seating).

The model used by the search module 110 may be a combination of algorithms, machine learning, or other functionality configured for generating an appropriate rule set to use in the destination search. The model may be revised or improved based on user feedback, user reviews, or other coaching or teaching derived from user activity, current data, or historical data.

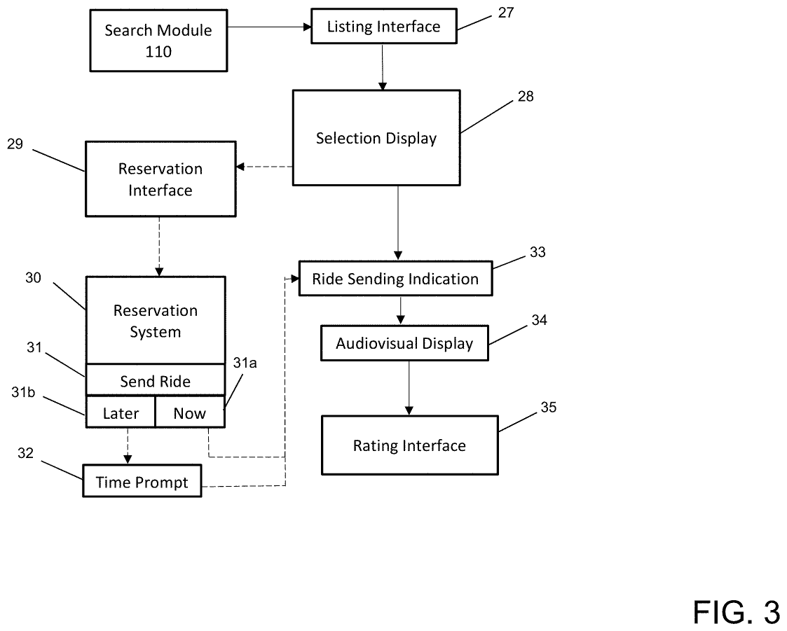

Referring to FIG. 3, the DMI 15 further comprises a listing interface 27, which is an interface in the DMI 15 through which a list of destinations is presented, where the listed destinations are derived from the search module's 110 database search based on the user 12 selected criteria. These criteria include information, categories, and subcategories, as described above. For example, if a distance selection of five (5) miles was selected for the “Restaurants” category option 24 with “American” cuisine selected for the subcategory option 26, the listing interface 27 displays the search results showing restaurant destinations matching this criteria. The list of destinations may be adjusted based on user 12 defined preferences or hierarchies of the relevant search criteria, as described above.

The DMI 15 may present the user 12 with the option to access more detailed information about each option appearing in the results list, such as by clicking on a hyperlink associated with a particular search result. If the user 12 does so, detailed information is displayed in a selection display 28. The selection display 28 presents information such as ratings of the selected destination by prior users 12 of the ride sharing service 11, the latest user 12 reviews of the selected destination, a description of the selected destination, what the ride sharing fare would be for the current user 12 to be driven to the selected destination, and electronic functionality that, when selected by the user 12, summons a ride to the destination via the ride sharing system 11. For example, in one embodiment the electronic functionality is a hyperlink that is labeled “Take Me Here,” the activation of which summons a ride from the ride sharing service 10 for the user 12. Optionally, the DMI 15 provides electronic functionality through which the user 12 selects the pickup time for the ride sharing service 10 to arrive to pick up the user 12.

One embodiment of the DMI 15 further comprises a reservation interface 29, which provides electronic functionality that enables the user 12 to electronically submit and secure a reservation for an event at the selected destination. For example, the user 12 could engage the reservation interface 29 electronic functionality to secure a reservation at a restaurant, reserve space on a tour, reserve a private viewing at a museum, or reserve space at similar events. The reservation interface 29 presents the user 12 with a reservation system 30 that queries whether the user 12 would like to make such a reservation. One embodiment of this reservation system 30 presents the user 12 with electronic functionality (such as one or more touchscreen options) that enables the user 12 to enter a “yes” or “no” answer.

If the user 12 selects a positive answer to the reservation query, the reservation interface 29 electronically submits the user's 12 reservation request either directly to the destination operator 50 (see FIG. 1), or through a third party electronic platform. Either type of electronic communication reaches the destination operator 50 through a destination operator device 51, which is a computer, laptop, or mobile device configured for electronic communications with the ride sharing system 11 and/or the user's mobile device 14. For example, in one embodiment the DMI 15 electronically submits the reservation request through the ride sharing service's 10 electronic system to the system of the operator of the restaurant. In another embodiment, the DMI 15 navigates the user 12 to a third party reservation system 30, such as the OpenTable® restaurant reservation system, to complete the reservation.

Once a reservation is completed by the user 12, the DMI 15 presents the user 12 with a ride scheduling interface 31, which comprises electronic functionality through which the user 12 engages the ride sharing system 11 to schedule a ride. The user 12 can elect to have a ride sent now 31a or at a later time 31b. If the user 12 selects now 31a, the ride sharing system 11 communicates this request to the ride sharing service 10, and the user 12 is presented with the ride sending indication 33, as discussed below. If the user 12 selects later 31b, the ride scheduling interface 31 presents the user 12 with in time prompt 32 through which the user 12 enters the later time at which the ride should be sent.

Some selections by the user 12 are not amenable to reservations, such as when the user 12 selects a restaurant or some other destination that does not accept reservations. In these instances, the DMI 15 omits the reservation interface 29 and provides the user 12 with a graphical ride sending indication 33 that the ride sharing service 10 is sending the requested ride. If the user 12 elects not to make a reservation, or if the selected destination does not offer reservations, then the DMI 15 navigates the user 12 from the selection display 28 to the ride sending indication 33. In one embodiment, the DMI 15 navigates the user 12 to the ride sharing system 11, through which the ride sending indication 33 is presented to the user 12.

While the user 12 is waiting for the ride to arrive for pickup, the DMI 15 presents the user 12 with an audiovisual display 34, which displays multimedia advertisements and promotions in connection with the ride sharing service 10, the destination operator 50, or another advertiser. In one embodiment of the DMI 15, the audiovisual display 34 is communicated to the destination operator 50, which promotes the ride sharing service 10 and/or the DMI 15 to the destination operator 50. This embodiment of the audiovisual display 34 communicates to the destination operator 50 how to sign up to be a partner destination or a preferred destination on the DMI 15.

After the ride is completed and the user 12 is dropped off at the destination, the DMI 15 presents the user 12 with a rating interface 35, which comprises electronic functionality that enables a user 12 to enter a rating of the destination and to write a review of the destination. The rating interface 35 is presented to the user 12 at some time after the drop off, such as an hour later, or a day later, or at some other time.

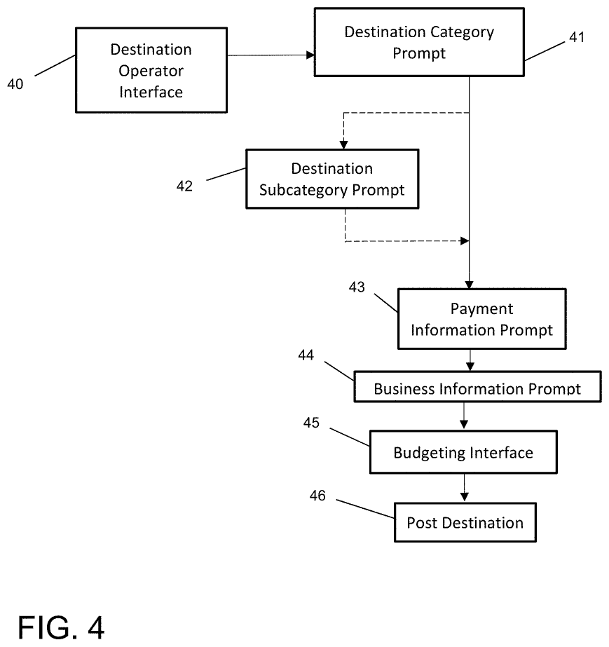

Referring to FIG. 4, one embodiment of the DMI 15 further comprises a destination operator interface (“DOI”) 40, which provides electronic functionality through which a destination operator 50 engages the DMI 15. For example, the destination operator 50 accesses a business connection interface to obtain approval of its business destination as a destination accessible and available through the DMI 15. In one embodiment, this includes the DMI 15 adding the destination to a designated database that the DMI 15 searches in response to user 12 selected criteria, as discussed above. The destination operator 50 may use this and other data or information to establish a destination profile in the destination database where the profile is searchable by the search module 110.

In one embodiment of creating the destination profile, after the destination operator 50 accesses the DOI 40, the DOI 40 presents the destination operator 50 with a destination category prompt 41, which provides or engages electronic functionality through which the DMI 15 receives destination category information entered by the destination operator 50 about the destination. The destination category prompt 41 cues the destination operator 50 to enter or select the type of destination, whether a restaurant, sports venue, bar, or some other destination. In other words, the destination category prompt 41 cues the destination operator 50 to enter or select information responsive to the category options 24 discussed above.

Next, the DOI 40 presents the destination operator 50 with a destination subcategory prompt 42, which provides or engages electronic functionality through which the DMI 15 receives information entered by the destination operator 50 about the destination subcategory. The destination subcategory prompt 42 presents a cue to the destination operator 50 to enter or select information responsive to the subcategory options 26 discussed above. Multiple subcategories may be selected or entered by the destination operator 50. For example, if the destination is a restaurant, the destination operator 50 may enter all subcategories that apply to its business, such as multiple subcategories of types of cuisine, multiple price points (e.g., a lunch price point and a dinner price point), multiple types of ambiance (e.g., a formal dining room and a separate bar area), or the like.

Next, the DOI 40 presents the destination operator 50 with a payment information prompt 43, which provides or engages electronic functionality through which the DMI 15 receives information entered by the destination operator 50 about its agreed payment methods and account information. When a user 12 uses the ride sharing system 11 to obtain a ride to the destination operator's 50 destination, the ride sharing service 10 charges a fee to the destination operator 50. This fee is processed through either the ride sharing system 11 or through the DMI 15, and the payment of the fee is secured via the payment information that the destination operator 50 enters or selects through the payment information prompt 43. The payment information could be a credit card number, a bank account number for ACH payment processing, or a third party payment service such as Apple Pay, PayPal, or some other service.

Next, the DOI 40 presents the destination operator 50 with a business information prompt 44, which provides or engages electronic functionality through which the DMI 15 receives information entered by the destination operator 50 about its business information. This business information comprises information such as a description of the business, hours of operation, and other features or information about the destination that would be of interest to users 12. This business information is viewable by the user 12 though the selection display 28.

Optionally, the DOI 40 presents the destination operator 50 with a budgeting interface 45, which provides or engages electronic functionality through which the DMI 15 receives information entered by the destination operator 50 about the destination operator's 50 account limits for its account with the DMI 15 or with the ride sharing service 10. As one exemplary option, the destination operator 50 enters a budgeting limit per payment period, such a week, a month, or a year. When the fees described above from the ride sharing service 10 to the destination operator 50 reach the budgeting limit, the ride sharing service 10 de-lists the destination from the ride sharing system 11 and/or the DMI 15, and no further fees are charged to the destination operator 50 during that payment period. Once the payment period ends, the destination is automatically re-listed at the beginning of the subsequent payment period with a new budget limit in place for the new payment period.

Once all of the steps of the DOI 40 above have been completed, the DOI 40 concludes the destination setup when the destination operator 50 actuates an indication that it has completed the destination setup process. For example, the destination operator 50 may click a “Post Destination” prompt 46 when the DOI 40 presents this prompt to the destination operator 50.

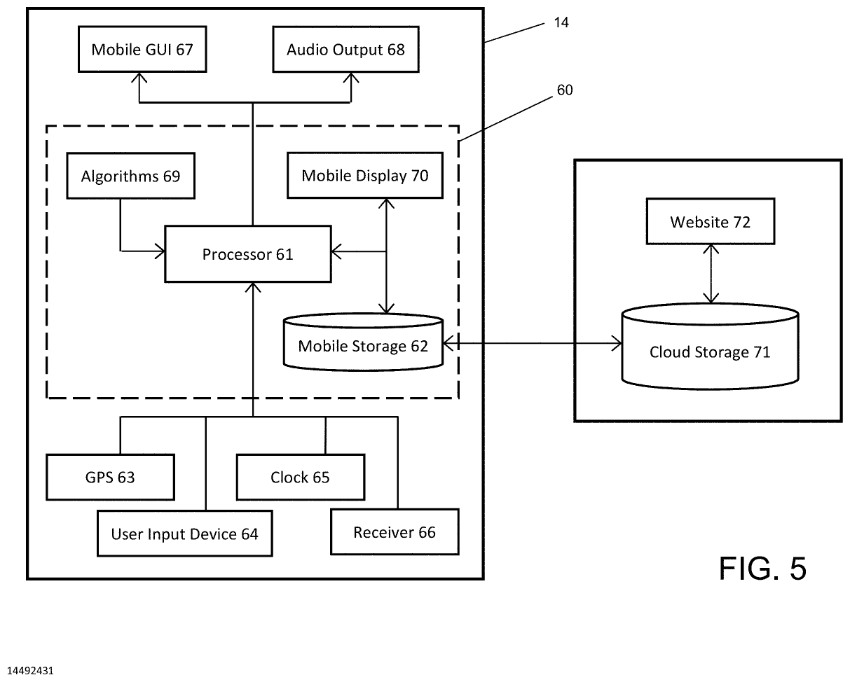

In one embodiment, the DMI 15 electronic functionality and interfaces described above are executed via a mobile application 60 deployed on the user's 12 mobile device 14. Referring to FIG. 5, the mobile device 14 is a smartphone, tablet, smart watch, laptop, or similar mobile or wearable device. The mobile device 14 comprises at least a processor 61 and mobile storage 62. The processor 61 is a component of the mobile device 14 that provides electronic processing electronic functionality. For example, various embodiments of the processor 61 include processing circuitry in one or more devices, which may perform independently from each other, or in tandem with each other through a bus that enables independent execution of instructions. Such processors 61 and processing devices include single-core and multi-core processors deployable on the mobile device 14.

The mobile storage 62 of the mobile device 14 communicates with the processor 61 via a bus for communicating data and information among the components of the mobile device 14. The mobile storage 62 comprises non-transient memory and/or other memories for storing data, information, instructions, tables, content, applications, data structures, and/or other components for carrying out the DMI 15 electronic functionality, interfaces, and other features described above. Various embodiments of the mobile storage 62 further comprise transient memory, or volatile or non-volatile memories, such as a computer readable storage medium.

Various embodiments of the mobile device 14 further comprise one or more of a global positioning system (“GPS”) 63, a user input device 64, a clock 65, an audio receiver 66, a mobile GUI 67, and an audio output 68. The GPS 63 is a component that identifies and tracks the location of the GPS 63, and therefore the mobile device 14, in relation to a global positioning coordinate system or reference system.

The user input device 64 comprises hardware that enables the user 12 to input information into the DMI 15. Various embodiments of the user input device 64 include a keypad, a touch screen, a roller ball, buttons, biometric sensors, or other similar devices or hardware. The clock 65 is a time keeping electronic functionality configured to provide the current time in the local time zone as determined by the location of the GPS 63.

The audio receiver 66 is a microphone or other audio receiver configured for receiving audio signals from the proximity of the mobile device 14. For example, in one embodiment, the audio receiver 66 is a microphone that receives an audio signal, such as the user's 12 voice, and converts the audio signal into a digital or other electronic signal.

The mobile GUI 67 is an interface for the user 12 to graphically interact with the mobile device 14. For example, embodiments of the GUI 67 include a touch screen and other interactive and non-interactive screens, monitors, or indicators. In one embodiment, the GUI 63 is a touch screen that also functions as the user input device 64.

The audio output 68 is a system configured to produce audio signals hearable by the user 12. In one embodiment, the audio output 68 comprises a speaker for emitting output information in audio form, or an electronic jack, interface, or local wireless network (such as Bluetooth, for example) for communicating or interfacing with such a speaker.

In one embodiment, the DMI 15 comprises one or more algorithms 69 that provide instructions for carrying out the electronic functionality and interfaces described above for the various embodiments of the DMI 15. In doing so, the algorithms 69 use data and information generated by the GPS 63, the user input device 64, the clock 65, the audio receiver 66, and through other functions or features of the mobile device 14. Execution of the algorithms 69 on this data produces an output, which is stored in the mobile storage 62 and/or displayed via the mobile display 70. As another example, the algorithms 69 may provide instructions for deploying and operating the model of the search module 110 that establishes the rule set for performing searches of the destination database based on the user 12 selected criteria.

In one embodiment, the DMI 15 further comprises a mobile display 70, which is a graphical display of the DMI 15 for presenting the type and format of information, prompts, and indications generated by the DMI 15 for the user 12. For example, in various embodiments, the mobile display 70 is configured to present at least one of more of the distance selection prompt 22, category prompt 23, category options 24, subcategory options 26, the listing interface 27, the selection display 28, the ride scheduling interface 31, the time prompt 32, the ride sending indication 33, the audiovisual display 34, and the rating interface 35. In an embodiment of the DMI 15, the mobile display 70 is configured for presenting the functions, features, prompts, and interfaces of the DOI 40 described above.

In another embodiment, the mobile application 60 is cloud enabled such that at least a portion of the electronic functionality of the mobile storage 62 or other functions or features of the mobile application 60 are supported by, or executed by, a remote server unit. For example, data arising from execution of the algorithms 69 on the data generated by the components of the mobile device 14 is stored in the mobile storage 62 and backed up to the cloud storage 71. The backed up data is then available for display via a website 72 accessible from the mobile device 12, the destination operator device 51, or a device used by the ride sharing service 10.

In another embodiment, the mobile application 60 is an embodiment of the ride sharing system 11, and the DMI 15 is deployed as a component of the ride sharing system 11 mobile application 60.

The foregoing embodiments are merely representative of the destination management interface and not meant for limitation of the invention. For example, persons skilled in the art would readily appreciate that there are several embodiments and configurations of the mobile applications, interfaces, prompts, and other components will not substantially alter the nature of the destination management interface. Likewise, elements and features of the disclosed embodiments could be substituted or interchanged with elements and features of other embodiments, as will be appreciated by an ordinary practitioner. Consequently, it is understood that equivalents and substitutions for certain elements and components set forth above are part of the invention described herein, and the true scope of the invention is recited in the claims below.

I claim:

1. A computer-implemented method comprising:
receiving a user-specified search request for a destination in relation to user-selected criteria;
applying, via a search module, a rule set to information in a destination database based upon the user-selected criteria in the user-specified search request, the rule set adapted to generate a set of destination listings most relevant to the user-selected criteria in the user-specified search request;
displaying the set of destination listings in an listing interface in a destination management interface deployed on a user device;
upon user selection of electronic functionality for securing a reservation at a user-selected destination that is included in the set of destination listings, deploying a reservation interface having electronic functionality for securing a reservation for an event at the user-selected destination; and
upon user selection of electronic functionality for reserving a ride to the user-selected destination, deploying a ride scheduling interface in the destination management interface, the ride scheduling interface having electronic functionality through which the user engages a ride sharing interface to schedule a ride to the user-selected destination in connection with the reservation.

2. The computer-implemented method of claim 1, wherein the step of deploying the reservation interface further comprises the step of electronically submitting the user's reservation request to an operator of the user-selected destination or to a third party electronic reservation system.

3. The computer-implemented method of claim 2, further comprising the step of presenting the user with an audiovisual display deployed via the destination management interface, the audiovisual display providing information to the user regarding promotions or services of the ride sharing service or the user-selected destination.

4. The computer-implemented method of claim 3, further comprising the step of electronically communicating the audiovisual display to the operator of the user-selected destination.

5. The computer-implemented method of claim 4, wherein the step of deploying electronic functionality through which the user engages the ride sharing interface to schedule a ride further comprises the step of deploying electronic functionality through which the user selects the pickup time for the ride sharing service.

6. The computer-implemented method of claim 1, further comprising the step of deploying a destination operator interface via a destination operator device, the destination operator interface providing electronic functionality for receiving destination operator data provided by an operator of the user-selected destination.

7. The computer-implemented method of claim 6, wherein the step of deploying the reservation interface further comprises the step of electronically submitting the user's reservation request to an operator of the user-selected destination or to a third party electronic reservation system.

8. The computer-implemented method of claim 7, further comprising the step of presenting the user with an audiovisual display deployed via the destination management interface, the audiovisual display providing information to the user regarding promotions or services of the ride sharing service or the user-selected destination.

9. The computer-implemented method of claim 8, further comprising the step of electronically communicating the audiovisual display to the operator of the user-selected destination.

10. The computer-implemented method of claim 9, wherein the step of deploying electronic functionality through which the user engages the ride sharing interface to schedule a ride further comprises the step of deploying electronic functionality through which the user selects the pickup time for the ride sharing service.

11. A non-transitory computer-readable storage medium storing computer program instructions that are executable by one or more processors of a system to perform the method comprising:
receiving a user-specified search request for a destination in relation to user-selected criteria;
applying, via a search module, a rule set to information in a destination database based upon the user-selected criteria in the user-specified search request, the rule set adapted to generate a set of destination listings most relevant to the user-selected criteria in the user-specified search request;
displaying the set of destination listings in an listing interface in a destination management interface deployed on a user device;
upon user selection of electronic functionality for securing a reservation at a user-selected destination that is included in the set of destination listings, deploying a reservation interface having electronic functionality for securing a reservation for an event at the user-selected destination; and
upon user selection of electronic functionality for reserving a ride to the user-selected destination, deploying a ride scheduling interface in the destination management interface, the ride scheduling interface having electronic functionality through which the user engages a ride sharing interface to schedule a ride to the user-selected destination in connection with the reservation.

12. The computer-implemented method of claim 11, wherein the step of deploying the reservation interface further comprises the step of electronically submitting the user's reservation request to an operator of the user-selected destination or to a third party electronic reservation system.

13. The computer-implemented method of claim 12, further comprising the step of presenting the user with an audiovisual display deployed via the destination management interface, the audiovisual display providing information to the user regarding promotions or services of the ride sharing service or the user-selected destination.

14. The computer-implemented method of claim 13, further comprising the step of electronically communicating the audiovisual display to the operator of the user-selected destination.

15. The computer-implemented method of claim 14, wherein the step of deploying electronic functionality through which the user engages the ride sharing interface to schedule a ride further comprises the step of deploying electronic functionality through which the user selects the pickup time for the ride sharing service.

16. The computer-implemented method of claim 11, further comprising the step of deploying a destination operator interface via a destination operator device, the destination operator interface providing electronic functionality for receiving destination operator data provided by an operator of the user-selected destination.

17. The computer-implemented method of claim 16, wherein the step of deploying the reservation interface further comprises the step of electronically submitting the user's reservation request to an operator of the user-selected destination or to a third party electronic reservation system.

18. The computer-implemented method of claim 17, further comprising the step of presenting the user with an audiovisual display deployed via the destination management interface, the audiovisual display providing information to the user regarding promotions or services of the ride sharing service or the user-selected destination.

19. The computer-implemented method of claim 18, further comprising the step of electronically communicating the audiovisual display to the operator of the user-selected destination.

20. The computer-implemented method of claim 19, wherein the step of deploying electronic functionality through which the user engages the ride sharing interface to schedule a ride further comprises the step of deploying electronic functionality through which the user selects the pickup time for the ride sharing service.
